(19) United States
(12) Patent Application Publication
(10) Pub. No.: US 2011/0043128 A1
(43) Pub. Date: Feb. 24, 2011

(54) CIRCUIT DEVICE DRIVING METHOD AND CIRCUIT DEVICE

(75) Inventor: Masashi Otsuka, Yamanashi (JP)

Correspondence Address: YOUNG & THOMPSON, 209 Madison Street, Suite 500, Alexandria, VA, 22314, US

(73) Assignees: PIONEER CORPORATION, KANAGAWA (JP); PIONEER MICRO TECHNOLOGY CORPORATION, YAMANASHI (JP)

(21) Appl. No.: 12/935,362

(22) PCT Filed: Apr. 3, 2008
(86) PCT No.: PCT/JP2008/056692

§ 371 Date: Oct. 29, 2010

(51) Int. Cl. H05B 37/02

(52) U.S. Cl. 315/291

(57) ABSTRACT

A drive method for a circuit apparatus includes: a cold cathode electron-emission element; a MOS transistor in which one of a source region and a drain region is electrically connected to one electrode of the cold cathode electron-emission element; a first voltage source electrically connected to another electrode of the cold cathode electron-emission element; and a second voltage source which is electrically connected to a semiconductor well region in which the MOS transistor is formed. The drive method is provided with: an electron-emission part forming process in which a first potential signal is outputted from the first voltage source and a second potential signal, which is different from the second potential signal, is outputted from the second voltage source so that a forward current flows in a p-n junction between the semiconductor well region and the one region when an electron-emission part is formed in the cold cathode electron-emission element.

### TECHNICAL FIELD

The present invention relates to a drive method of driving a circuit apparatus which is electrically connected to an electron-emission element such as a high efficiency electron-emission device (HEED) and a surface-conduction electron-emitter display (SED), and to the circuit apparatus.

### BACKGROUND ART

As this type of drive method, for example, there has been suggested such a technology that, in a semiconductor integrated circuit having a substrate bias circuit, a substrate bias is applied to a MOS transistor and the threshold value of the MOS transistor is increased to reduce a leakage current in a standby mode and that the substrate bias is not applied to the MOS transistor and the threshold value of the MOS transistor is reduced to allow a high-speed operation in an operation mode (refer to patent documents 1 and 2).

Alternatively, there has been suggested such a technology that, in a MOS circuit made of a plurality of MOSFETs for forming a digital circuit, a back bias voltage is applied to a semiconductor substrate or semiconductor well region so that a forward voltage may appear across a p-n junction between a source region and the semiconductor substrate or the semiconductor well region in which the MOSFETs are formed, under the condition that the operations of the MOSFETs are not influenced, by which a drain current necessary for the high-speed operation is obtained (refer to a patent document 3).

Moreover, as a method of producing a circuit apparatus in which this type of drive method is used, for example, a production method of performing an energization forming process has been suggested in which an electron-emission part is formed via diode elements, which are connected in series to the surface-conduction electron-emitter display, when the electron-emission part is formed in the surface-conduction electron-emitter display (refer to a patent document 4). Moreover, as the circuit apparatus in which this type of drive method is used, there has been suggested an element drive circuit including the MOSFETs, which are electrically connected to the high efficiency electron-emission device (refer to a patent document 5).

Patent document 1: Japanese Patent Application Laid Open No. Hei 5-108194
Patent document 2: International Publication WO97/32399
Patent document 3: International Publication WO00/45437
Patent document 4: Japanese Patent Application Laid Open No. Hei 8-180799
Patent document 5: Japanese Patent Application Laid Open No. Hei 2005-228556

### DISCLOSURE OF INVENTION

### Subject to be Solved by the Invention

When the electron-emission part is formed in the electron-emission element by the circuit apparatus in which this type of drive method is used, a high voltage is to be applied to the electron-emission element. Thus, if the formation of the electron-emission part is mediated by the MOSFET for drive, disclosed in the patent documents 1 to 3, and 5, it is hardly possible to miniaturize or reduce it in size in order to ensure a withstanding voltage of the MOSFET, which is technically problematic. Alternatively, due to the miniaturization or reduction in size of the MOSFET for drive, a sufficient withstanding voltage cannot be ensured, and the electron-emission part is likely not formed, which is also technically problematic. On the other hand, in the technology disclosed in the patent document 4, the diode needs to be formed separately. This makes the downsizing harder and likely increase production costs, which are also technically problematic.

In view of the aforementioned problems, it is therefore an object of the present invention to provide, for example, a drive method for a circuit apparatus, which allows the circuit apparatus to be downsizing_while an electron-emission part is appropriately formed in an electron-emission element, and provide the circuit apparatus.

### Means for Solving the Subject

The above object of the present invention can be achieved by a drive method for a circuit apparatus provided with: a cold cathode electron-emission element; a MOS transistor in which one of a source region and a drain region is electrically connected to one electrode of the cold cathode electron-emission element; a first voltage source which is electrically connected to another electrode of the cold cathode electron-emission element; and a second voltage source which is electrically connected to a semiconductor well region in which the MOS transistor is formed, the drive method comprising: an electron-emission part forming process in which a first potential signal is outputted from the first voltage source and a second potential signal, which is different from the second potential signal, is outputted from the second voltage source so that a forward current flows in a p-n junction between the semiconductor well region and the one region when an electron-emission part is formed in the cold cathode electron-emission element.

According to the drive method for the circuit apparatus of the present invention, the circuit apparatus is provided with the cold cathode electron-emission element such as a HEED and a SED; a MOS transistor in which one of a source region and a drain region is electrically connected to one electrode of the cold cathode electron-emission element; a first voltage source which is electrically connected to another electrode of the cold cathode electron-emission element; and a second voltage source which is electrically connected to a semiconductor well region in which the MOS transistor is formed.

Incidentally, the “MOS transistor” of the present invention is, for example, a MOS transistor for high voltage, a MOS transistor for low voltage, a MOS transistor with a DDD structure, a MOS transistor with a LOCOS structure on one side, a MOS transistor with a LOCOS structure on both sides, or the like.

When the electron-emission part is formed in the cold cathode electron-emission element, in the electron-emission part forming process, the first potential signal is outputted from the first voltage source and the second potential signal, which is different from the second potential signal, is outputted from the second voltage source so that the forward current flows in the p-n junction between the semiconductor well region and the one region. Here, “when the electron-emission part is formed in the cold cathode electron-emission element” is not limited to when the electron-emission part is formed in the cold cathode electron-emission element, but may include when a conductive fine structure, which exists on the surface or inside of an insulating layer portion within the formed electron-emission part, is grown or increased.

According to the study of the present inventors, in the production process of the cold cathode electron-emission element, the process of forming the electron-emission part for functioning as the cold cathode electron-emission element (hereinafter, referred to as an “activation process” as occasion demands) is performed on the cold cathode electron-emission element (or in a strict sense, an element to be the cold cathode electron-emission element). The electric resistance of a portion to be the electron-emission part before the activation process is higher than the electric resistance of the electron-emission part after the activation process (e.g. about 10 times higher). Thus, in the activation process, a relatively high voltage is to be applied between the one electrode and the other electrode so that a predetermined current necessary to form the electron-emission part flows between the one electrode and the other electrode of the cold cathode electron-emission element. On the other hand, after the electron-emission part is formed, the electric resistance is relatively small, so a relatively low voltage may be applied between the one electrode and the other electrode when the cold cathode electron-emission element is driven.

Therefore, if it is only necessary to drive the cold cathode electron-emission element, the miniaturization or reduction in size of the MOS transistor for drive can be performed. However, if the activation process is performed via the MOS transistor for drive which is electrically connected to the cold cathode electron-emission element, it is hardly possible to miniaturize the circuit apparatus or reduce it in size in order to ensure a withstanding voltage of the MOS transistor for drive. On the other hand, if the activation process is performed via another member which is different from the MOS transistor for drive, it is found that the miniaturization or reduction in size of the circuit apparatus likely becomes harder in order to reserve a space for the other member, although the miniaturization or reduction in size of the MOS transistor for drive can be performed.

In the present invention, however, when the electron-emission part is formed in the cold cathode electron-emission element, the first potential signal is outputted from the first voltage source and the second potential signal, which is different from the first potential signal, is outputted from the second voltage source so that the forward current flows in the p-n junction between the semiconductor region and the one region. In other words, in the present invention, the p-n junction between the semiconductor well region and the one region is allowed to function as the diode in the activation process. Thus, a predetermined current necessary to form the electron-emission part in the activation process can be obtained at a relatively low voltage, and the miniaturization or reduction in size of the MOS transistor can be performed.

Incidentally, for example, a switching element is electrically connected to the other of the source region and the drain region of the MOS transistor. In the activation process, the switching element is turned OFF so that an electric current does not flow between the source region and the drain region.

When the cold cathode electron-emission element in which the electron-emission part is formed is driven, a predetermined potential signal is outputted from each of the first voltage source and the second voltage source so that a predetermined current flows between the source region and the drain region of the MOS transistor.

As a result, according to the drive method for the circuit apparatus of the present invention, it is possible to miniaturize or reduce the circuit apparatus in size while appropriately forming the electron-emission part in the electron-emission element.

In one aspect of the drive method for the circuit apparatus of the present invention, it is further provided with a driving process in which a third potential signal is outputted from the first voltage source and a fourth potential signal is outputted from the second voltage source so that an electric current flows between the source region and the drain region when the cold cathode electron-emission element in which the electron-emission is formed is driven

According to this aspect, when the cold cathode electron-emission element in which the electron-emission part is formed is driven, in the driving process, the third potential signal is outputted from the first voltage source and the fourth potential signal is outputted from the second voltage source so that an electric current flows between the source region and the drain region. This allows the MOS transistor to function as the switching element and an electron beam to appropriately emit from the cold cathode electron-emission element. As a result, it is possible to realize a display apparatus capable of displaying a high-quality display image or the like, which is extremely useful in practice.

In another aspect of the drive method for the circuit apparatus of the present invention, the cold cathode electron-emission element is a surface-conduction electron-emitter display, and the MOS transistor is an N-type MOS transistor.

According to this aspect, the MOS transistor is the N-type MOS transistor, so the potential indicated by the first potential signal is lower than the potential indicated by the second potential signal in the activation process. On the other hand, when the cold cathode electron-emission element is driven, the potential indicated by the third potential signal is higher than the potential indicated by the fourth potential signal.

In another aspect of the drive method for the circuit apparatus of the present invention, the cold cathode electron-emission element is a high efficiency electron-emission device, and the MOS transistor is a P-type MOS transistor.

According to this aspect, the MOS transistor is the P-type MOS transistor, so the potential indicated by the first potential signal is higher than the potential indicated by the second potential signal in the activation process. On the other hand, when the cold cathode electron-emission element is driven, the potential indicated by the third potential signal is less than or equal to the potential indicated by the fourth potential signal.

The above object of the present invention can be also achieved by a circuit apparatus provided with: a cold cathode electron-emission element; a MOS transistor in which one of a source region and a drain region is electrically connected to one electrode of the cold cathode electron-emission element; a first voltage source which is electrically connected to another electrode of the cold cathode electron-emission element; a second voltage source which is electrically connected to a semiconductor well region in which the MOS transistor is formed; and a switching device which is electrically connected to the other of the source region and the drain region, at least one portion of the MOS transistor functioning as at least one portion of a diode when an electron-emission part is formed in the cold cathode electron-emission element.

According to the circuit apparatus of the present invention, when the electron-emission part is formed in the cold cathode electron-emission element such as a HEED and a SED, at least one portion of the MOS transistor functions as at least one portion of the diode. For example, the p-n junction between the semiconductor well region and the one region functions as the diode. Thus, a predetermined current necessary to form the electron-emission part in the activation process can be obtained at a relatively low voltage, and the miniaturization or reduction in size of the MOS transistor can be performed.

Incidentally, in the activation process, the switching device is typically turned OFF so that an electric current does not flow between the source region and the drain region. On the other hand, when the cold cathode electron-emission element in which the electron-emission part is formed is driven, the switching device is turned ON so that an electric current flows between the source region and the drain region.

As a result, according to the circuit apparatus of the present invention, it is possible to miniaturize or reduce the circuit apparatus in size while appropriately forming the electron-emission part in the electron-emission element.

The operation and other advantages of the present invention will become more apparent from the best mode for carrying out the invention explained below.

### BRIEF DESCRIPTION OF DRAWINGS

FIG. 1 is a cross sectional view showing the structure of a circuit apparatus in a first embodiment.

FIG. 2 is an equivalent circuit schematic showing the circuit apparatus in the first embodiment.

FIG. 3 is a block diagram schematically showing the electrical structure of an image display apparatus in an example of the first embodiment.

FIG. 4 is a view showing one example of a potential signal inputted to each terminal and each wire in an activation process in the example of the first embodiment.

FIG. 5 is a view showing one example of the potential signal inputted to each terminal and each wire when a SED is driven in the example of the first embodiment.

FIG. 6 is a cross sectional view showing the structure of a circuit apparatus in a second embodiment.

FIG. 7 is an equivalent circuit schematic showing the circuit apparatus in the second embodiment.

FIG. 8 is a block diagram schematically showing the electrical structure of an image display apparatus in an example of the second embodiment.

FIG. 9 is a view showing one example of a potential signal inputted to each terminal and each wire in an activation process in the example of the second embodiment.

FIG. 10 is a view showing one example of the potential signal inputted to each terminal and each wire when a HEED is driven in the example of the second embodiment.

FIG. 11 is a cross sectional view showing the structure of a circuit apparatus in a third embodiment.

FIG. 12 is an equivalent circuit schematic showing the circuit apparatus in the third embodiment.

FIG. 13 is a block diagram schematically showing the electrical structure of an image display apparatus in an example of the third embodiment.

FIG. 14 is a view showing one example of a potential signal inputted to each terminal and each wire in an activation process in the example of the third embodiment.

FIG. 15 is a view showing one example of the potential signal inputted to each terminal and each wire when a SED is driven in the example of the third embodiment.

### DESCRIPTION OF REFERENCE CODES

1, 2, 3 circuit apparatus
11 N-type MOS transistor
P-type MOS transistor
NPN bipolar transistor
SED
HEED
30 substrate
41, 42, 43 interlayer insulating film
51, 52, 53, 54 wire
60 separation layer
71, 72 voltage source
SW switch

### BEST MODE FOR CARRYING OUT THE INVENTION

Hereinafter, embodiments of the drive method for the circuit apparatus of the present invention will be explained with reference to the drawings. Incidentally, in the following drawings, each layer and each member have different scales in order that each layer and each member are large enough to be recognized on the drawings.

### First Embodiment

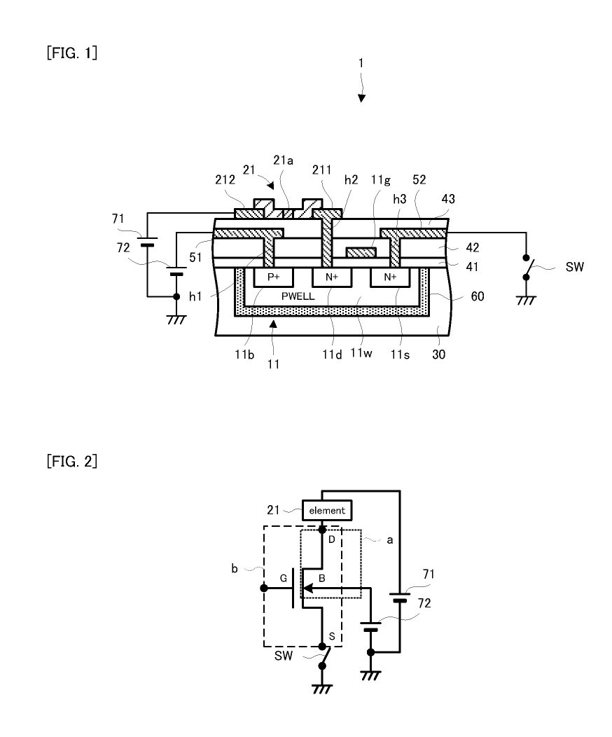

A first embodiment of the drive method for the circuit apparatus of the present invention will be explained with reference to FIG. 1 and FIG. 2.

Firstly, the structure of the circuit apparatus in the first embodiment will be explained with reference to FIG. 1. FIG. 1 is a cross sectional view showing the structure of the circuit apparatus in the first embodiment.

In FIG. 1, a circuit apparatus 1 is provided with an N-type MOS transistor 11, a SED 21, voltage sources 71 and 72, and a switch SW. Here, the “SED 21”, the “voltage source 71”, the “voltage source 72”, and the “switch SW” are one example of the “cold cathode electron-emission element”, the “first voltage source”, the “second voltage source”, and the “switching device” of the present invention, respectively. Incidentally, the voltage source 72 is a so-called substrate bias.

The N-type MOS transistor 11 is formed in a separation layer 60 disposed in a substrate 30. The N-type MOS transistor 11 is provided with a P-type well region 11w as one example of the “semiconductor well region” of the present invention, a substrate bias terminal 11b, a drain region 11d, a source region 11s, and a gate electrode 11g. Incidentally, because the N-type MOS transistor 11 is formed in the separation layer 60, even if an electric current is applied to the P-type well region 11w via the substrate bias terminal 11b, it is possible to avoid the electric current flowing to the adjacent N-type MOS transistor, which is extremely useful in practice. Incidentally, the separation layer 60 may be formed of a cavity formed by etching, of an insulating film, or by applying an opposite direction voltage not to make the electric current flow to the substrate 30, or in similar manners.

The SED 21 is provided with an electron-emission part 21a and electrodes 211 and 212. The electrode 211 is electrically connected to the drain region 11d via a contact hole h2 formed in interlayer insulating films 41 to 43. The electrode 212 is electrically connected to the voltage source 71. Here, the “electrode 211” and the “electrode 212” in the first embodiment are one example of the “one electrode” and the “other electrode” of the present invention, respectively.

The voltage source 72 is electrically connected to the substrate bias terminal 11b via a contact hole h1 formed in a wire 51 and the interlayer insulating films 41 and 42. The switch SW is electrically connected to the source region 11s via a contact hole h3 formed in a wire 52 and the interlayer insulating films 41 and 42.

Next, the drive method for the circuit apparatus 1 as constructed above will be explained with reference to FIG. 2. FIG. 2 is an equivalent circuit schematic showing the circuit apparatus in the first embodiment.

When the electron-emission part 21a is formed in the SED 21, a first potential signal is outputted from the voltage source 71 and a second potential signal, which is different from the first potential signal, is outputted from the voltage source 72 so that a forward current flows in a p-n junction between the P-type well region 11w and the drain region 11d (i.e. an electric current flows from the P-type well region 11w to the drain region 11d). Therefore, the potential indicated by the first potential signal is lower than the potential indicated by the second potential signal. Incidentally, at this time, the switch SW is turned OFF in order not to apply an electric current between the source region 11s and the drain region 11d. Moreover, the potential indicated by a potential signal inputted to the gate electrode 11g may have an arbitrary value.

As described above, in the first embodiment, the p-n junction between the P-type well region 11w and the drain region 11d (portion surrounded by a dotted line a in FIG. 2) is allowed to function as a diode in activation process. Thus, a predetermined current necessary to form the electron-emission part 21a in the activation process can be obtained at a relatively low voltage.

On the other hand, when the SED 21 in which the electron-emission part 21a is formed is driven, the switch SW is turned ON so that an electric current flows between the source region 11s and the drain region 11d, and then, a third potential signal is outputted from the voltage source 71, and a fourth potential signal is outputted from the voltage source 72. At this time, the potential indicated by the fourth potential signal is typically zero. The potential indicated by the third potential signal is higher than the potential indicated by the fourth potential signal. Incidentally, the potential indicated by a potential signal inputted to the gate electrode 11g is higher than the threshold value of the N-type MOS transistor 11.

As described above, in the first embodiment, when the SED 21 is driven, the N-type MOS transistor 11 (portion surrounded in a dashed line b in FIG. 2) is allowed to function as the N-type MOS transistor. Therefore, by driving the circuit apparatus 1 as described above, the activation process and drive of the SED 21 can be realized by one N-type MOS transistor 11, which is extremely useful in practice.

(Example)

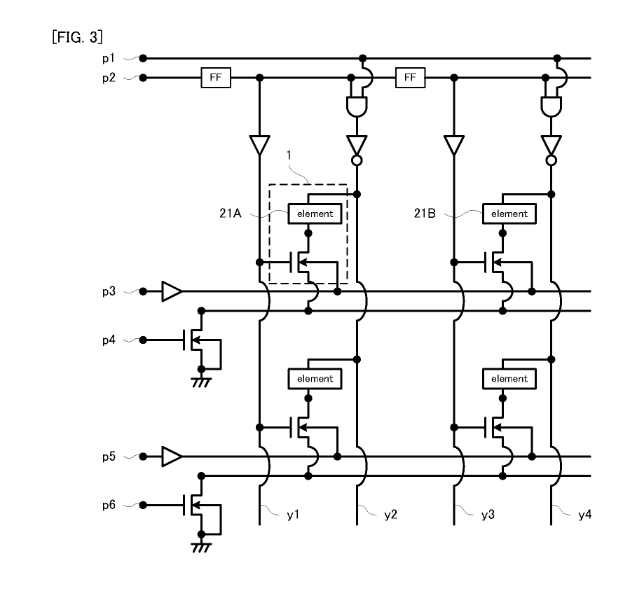

Next, an explanation will be given on an example in which the circuit apparatus in the first embodiment is applied to an image display apparatus, with reference to FIG. 3 to FIG. 5. FIG. 3 is a block diagram schematically showing the electrical structure of the image display apparatus in the example. Incidentally, “FF” in FIG. 3 indicates a flip-flop circuit.

In FIG. 3, the potential signal from the voltage source 71 (refer to FIG. 1) is inputted to a terminal p1. The potential signal to be inputted to the gate electrode 11g (refer to FIG. 1) (i.e. the potential signal for controlling the N-type MOS transistor 11) is inputted to a terminal p2. The potential signal from the voltage source 72 (refer to FIG. 1) is inputted to terminals p3 and p5. The potential signal for controlling the switch SW (refer to FIG. 1) is inputted to terminals p4 and p6.

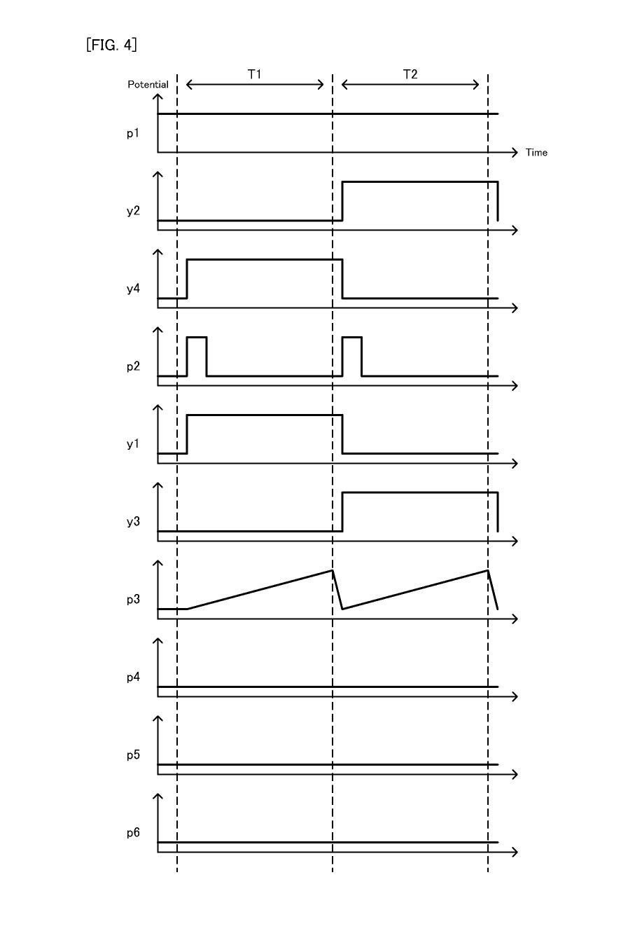

Next, an explanation will be given on the potential signal when the activation process is performed on the SED 21 on the image display apparatus, with reference to FIG. 4. FIG. 4 is a view showing one example of the potential signal inputted to each terminal and each wire in the activation process in the example. Incidentally, FIG. 4 shows the potential signal when the activation process is performed on two SEDs 21A and 21B adjacent to each other (refer to FIG. 3). Moreover, terms T1 and T2 in FIG. 3 indicate a term in which the activation process is performed on the SED 21A and a term in which the activation process is performed on the SED 21B, respectively.

As shown in FIG. 4, if the activation process is performed on the SED 21A (in the term T1 in FIG. 4), the potential indicated by the potential signal inputted to a wire y2 (or the potential signal inputted to the electrode 212 in FIG. 1, i.e. the first potential signal) is lower than the potential indicated by the potential signal inputted to the terminal p3 (or the potential signal inputted to the substrate bias terminal 11b, i.e. the second potential signal). Incidentally, the potential signal inputted to the terminal p4 is set such that an electric current does not flow between the source region 11s and the drain region 11d (refer to FIG. 1).

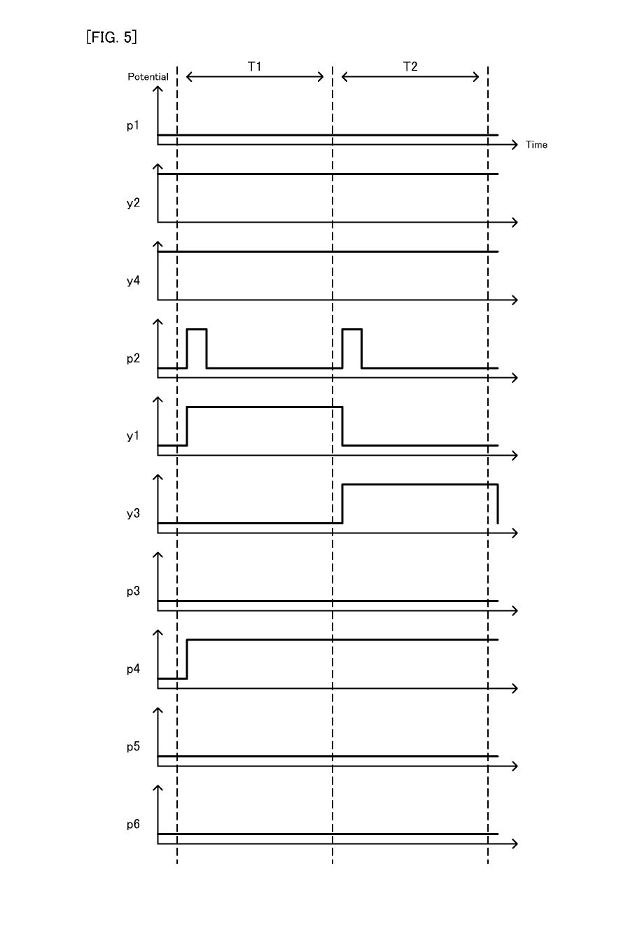

Next, an explanation will be given on the potential signal when the SED in which the electron-emission part 21a (refer to FIG. 1) is formed is driven, with reference to FIG. 5. FIG. 5 is a view showing one example of the potential signal inputted to each terminal and each wire when the SED is driven in the example.

As shown in FIG. 5, if the SED 21A is driven (in the term T1 in FIG. 5), the potential indicated by the potential signal inputted to the wire y2 (i.e. the third potential signal) is higher than the potential indicated by the potential signal inputted to the terminal p3 (i.e. the fourth potential signal). Incidentally, the potential signal inputted to the terminal p4 is set such that an electric current flows between the source region 11s and the drain region 11d.

### Second Embodiment

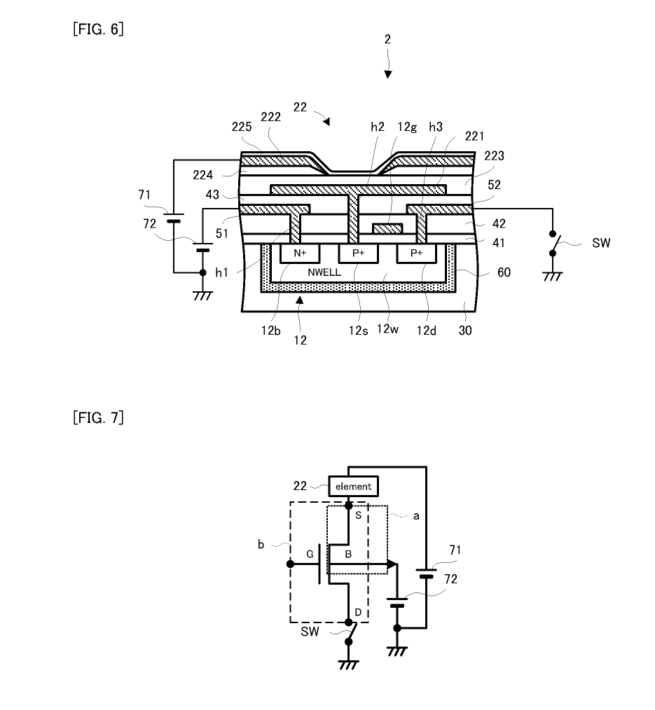

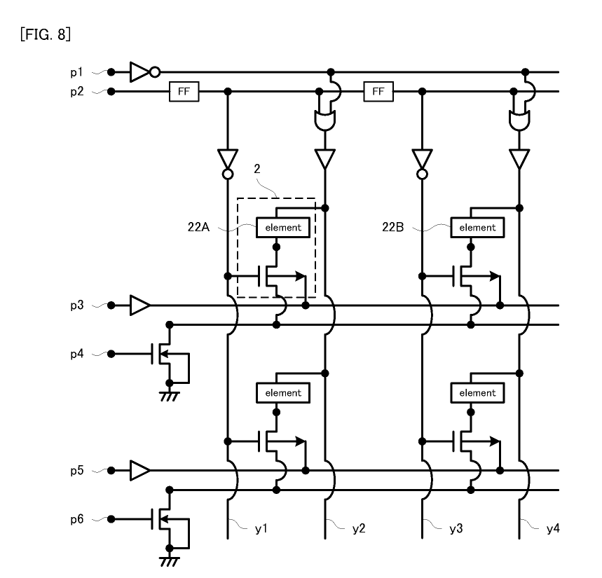

Next, a second embodiment of the drive method for the circuit apparatus of the invention will be explained with reference to FIG. 6 and FIG. 7. The second embodiment is the same as the first embodiment, except that the type of the cold cathode electron-emission element and the type of the MOS transistor are different. Thus, in the second embodiment, the repeated explanation of the first embodiment will be omitted, and the same points on the drawings will carry the same reference numerals, and basically, only different points will be explained with reference to FIG. 6 and FIG. 7. FIG. 6 is a cross sectional view showing the structure of the circuit apparatus in the second embodiment, to the same effect as FIG. 1.

In FIG. 6, a circuit apparatus 2 is provided with a P-Type MOS transistor 12, a HEED 22, voltage sources 71 and 72, and a switch SW. Here, the “HEED 22” in the second embodiment is another example of the “cold cathode electron-emission element” of the present invention.

The P-type MOS transistor 12 is provided with an N-type well region 12w as another example of the “semiconductor well region” of the present invention, a substrate bias terminal 12b, a source region 12s, a drain region 12d, and a gate electrode 12g.

The HEED 22 is provided with a lower electrode 221, an upper electrode 222, an electron supply layer 223 made of amorphous silicon or the like, an insulating film 224 made of silicon oxide or the like, and a carbon film 225. Here, the “lower electrode 221” and the “upper electrode 222” in the second embodiment are another example of the “one electrode” and the “other electrode” of the present invention, respectively. Incidentally, the vicinity o a desired portion of the HEED 22 corresponds to the electron-emission part.

The lower electrode 221 is electrically connected to the source region 12s via a contact hole h2. The upper electrode 222 is electrically connected to the voltage source 71. The voltage source 72 is electrically connected to the substrate bias terminal 12b via a wire 51 and a contact hole h1. The switch SW is electrically connected to the drain region 12d via a wire 52 and a contact hole h3.

Next, the drive method for the circuit apparatus 2 as constructed above will be explained with reference to FIG. 7. FIG. 7 is an equivalent circuit schematic showing the circuit apparatus in the second embodiment, to the same effect as FIG. 2.

When the electron-emission part is formed in the HEED 22, a first potential signal is outputted from the voltage source 71 and a second potential signal is outputted from the voltage source 72 so that a forward current flows in a p-n junction between the N-type well region 12w and the source region 12s. Therefore, the potential indicated by the first potential signal is higher than the potential indicated by the second potential signal.

On the other hand, when the HEED 22 in which the electron-emission part is formed is driven, a third potential signal is outputted from the voltage source 71 and a fourth potential signal is outputted from the voltage source 72 so that an electric current flows between the source region 12s and the drain region 12d. At this time, the potential indicated by the third potential signal is greater than zero and is less than or equal to the potential indicated by the fourth potential signal. Incidentally, the potential indicated by a potential signal inputted to the gate electrode 12g is lower than the threshold value of the P-type MOS transistor 12.

(Example)

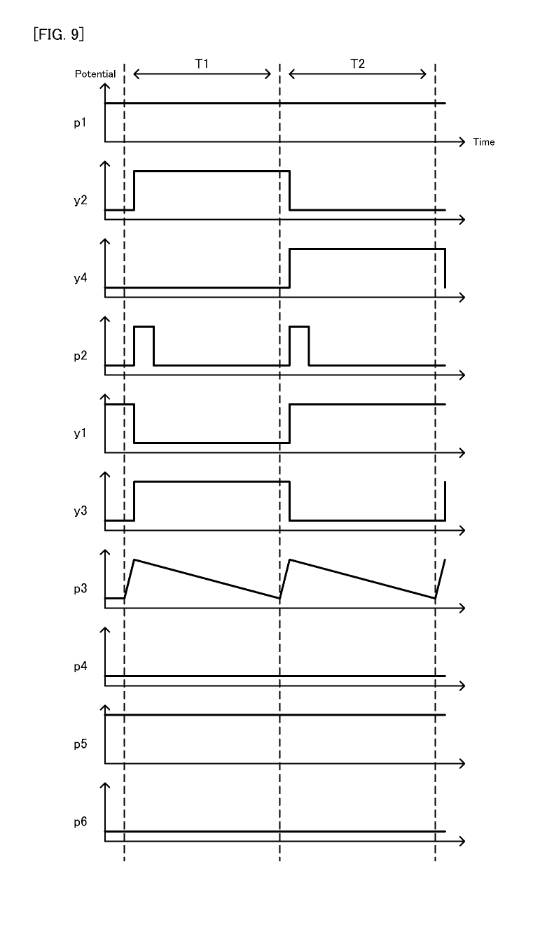

Next, an explanation will be given on an example in which the circuit apparatus in the second embodiment is applied to an image display apparatus, with reference to FIG. 8 to FIG. 10. FIG. 8 is a block diagram schematically showing the electrical structure of the image display apparatus in the example, to the same effect as FIG. 3.

Next, an explanation will be given on the potential signal when the activation process is performed on the HEED 22 on the image display apparatus, with reference to FIG. 9. FIG. 9 is a view showing one example of the potential signal inputted to each terminal and each wire in the activation process in the example, to the same effect as FIG. 4. Incidentally, FIG. 9 shows the potential signal when the activation process is performed on two HEEDs 22A and 22B adjacent to each other (refer to FIG. 8). Moreover, terms T1 and T2 in FIG. 9 indicate a term in which the activation process is performed on the HEED 22A and a term in which the activation process is performed on the HEED 22B, respectively.

As shown in FIG. 9, if the activation process is performed on the HEED 22A (in the term T1 in FIG. 9), the potential indicated by the potential signal inputted to a wire y2 (or the potential signal inputted to the upper electrode 222 in FIG. 6, i.e. the first potential signal) is higher than the potential indicated by the potential signal inputted to the terminal p3 (or the potential signal inputted to the substrate bias terminal 12b, i.e. the second potential signal).

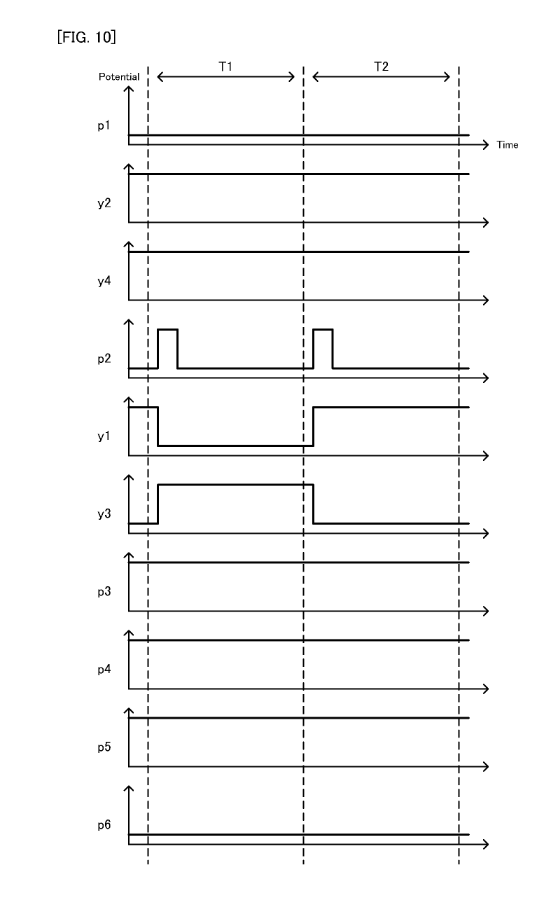

Next, an explanation will be given on the potential signal when the HEED 22 in which the electron-emission part is formed is driven, with reference to FIG. 10. FIG. 10 is a view showing one example of the potential signal inputted to each terminal and each wire when the HEED is driven in the example, to the same effect as FIG. 5.

As shown in FIG. 10, if the HEED 22A is driven (in the term T1 in FIG. 10), the potential indicated by the potential signal inputted to the wire y2 (i.e. the third potential signal) is less than or equal to the potential indicated by the potential signal inputted to the terminal p3 (i.e. the fourth potential signal).

### Third Embodiment

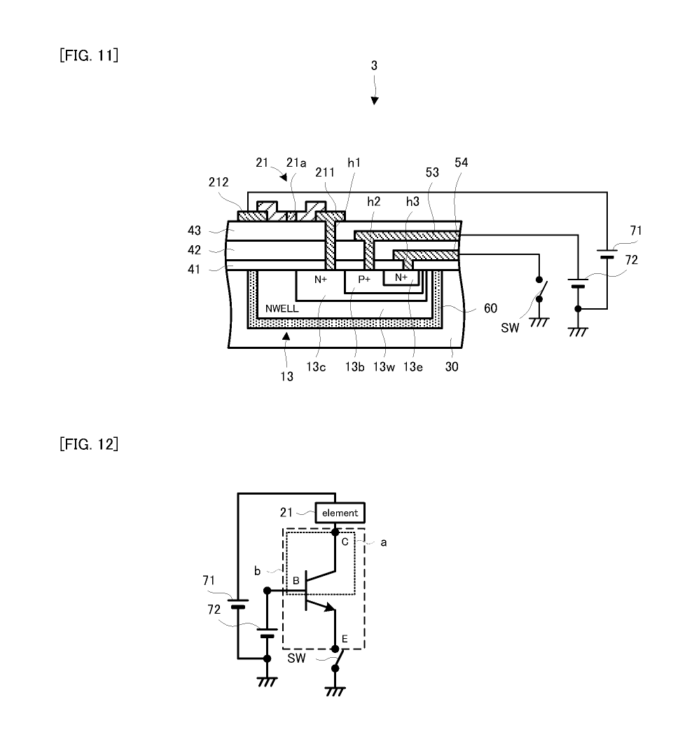

A third embodiment of the drive method for the circuit apparatus of the present invention will be explained with reference to FIG. 11 and FIG. 12.

Firstly, the structure of the circuit apparatus in the first embodiment will be explained with reference to FIG. 1. FIG. 1 is a cross sectional view showing the structure of the circuit apparatus in the first embodiment. The third embodiment is the same as the first embodiment, except that the type of transistor is different. Thus, in the third embodiment, the repeated explanation of the first embodiment will be omitted, and the same points on the drawings will carry the same reference numerals, and basically, only different points will be explained with reference to FIG. 11 and FIG. 12. FIG. 11 is a cross sectional view showing the structure of the circuit apparatus in the third embodiment, to the same effect as FIG. 1.

In FIG. 11, a circuit apparatus 3 is provided with an NPN bipolar transistor 13, a SED 21, voltage sources 71 and 72, and a switch SW. The NPN bipolar transistor 13 is provided with an N-type well region 13w, a collector region 13c, a base region 13b, and an emitter region 13e.

An electrode 211 is electrically connected to the collector region 13c via a contact hole h1. The voltage source 72 is electrically connected to the base region 13b via a wire 53 and a contact hole h2. The switch SW is electrically connected to the emitter region 13e via a wire 54 and a contact hole h3.

Next, the drive method for the circuit apparatus 3 as constructed above will be explained with reference to FIG. 12. FIG. 12 is an equivalent circuit schematic showing the circuit apparatus in the third embodiment, to the same effect as FIG. 2.

When an electron-emission part 21a is formed in the SED 21, a first potential signal is outputted from the voltage source 71 and a second potential signal is outputted from the voltage source 72 so that a forward current flows in a p-n junction between the collector region 13c and the base region 13b. Therefore, the potential indicated by the first potential signal is lower than the potential indicated by the second potential signal. Incidentally, the switch SW is turned OFF in order not to apply an electric current in the emitter region 13e.

On the other hand, when the SED 21 in which the electron-emission part 21a is formed is driven, a third potential signal is outputted from the voltage source 71 and a fourth potential signal is outputted from the voltage source 72 so that the NPN bipolar transistor 13 operates. Therefore, the potential indicated by the third potential signal is higher than the potential indicated by the fourth potential signal. Incidentally, the switch SW is turned ON.

(Example)

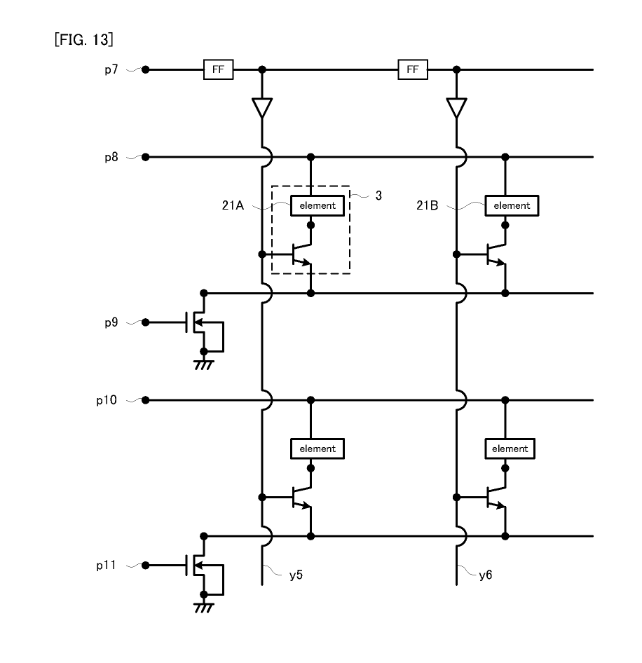

Next, an explanation will be given on an example in which the circuit apparatus in the third embodiment is applied to an image display apparatus, with reference to FIG. 13 to FIG. 15. FIG. 13 is a block diagram schematically showing the electrical structure of the image display apparatus in the example, to the same effect as FIG. 3.

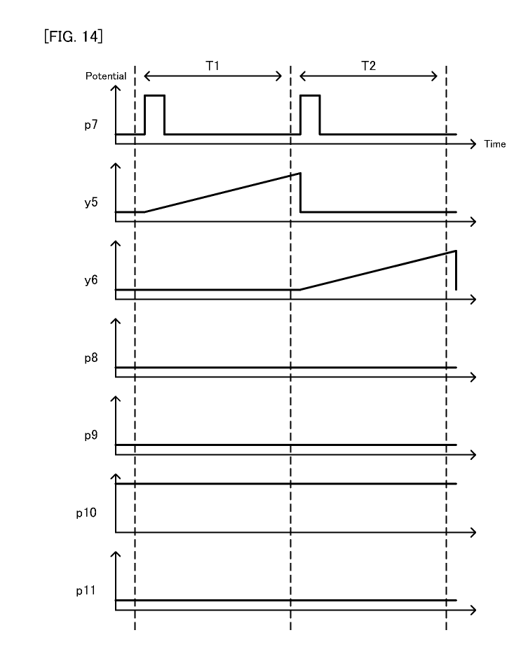

In FIG. 13, the potential signal from the voltage source 72 (refer to FIG. 11) is inputted to a terminal p7. The potential signal from the voltage source 71 (refer to FIG. 11) is inputted to a terminal p8 and a terminal p10. The potential signal for controlling the switch SW (refer to FIG. 11) is inputted to terminals p9 and p11. Next, an explanation will be given on the potential signal when the activation process is performed on the SED 21 on the image display apparatus, with reference to FIG. 14. FIG. 14 is a view showing one example of the potential signal inputted to each terminal and each wire in the activation process in the example, to the same effect as FIG. 4.

As shown in FIG. 14, if the activation process is performed on a SED 21A (refer to FIG. 13) (in the term T1 in FIG. 14), the potential indicated by the potential signal inputted to the terminal p8 (or the potential signal inputted to an electrode 212 in FIG. 11, i.e. the first potential signal) is lower than the potential indicated by the potential signal inputted to a wire y5 (or the potential signal inputted to the base region 13b, i.e. the second potential signal). Incidentally, the potential signal inputted to the terminal p9 is set such that an electric current does not flow in the emitter region 13e (refer to FIG. 11).

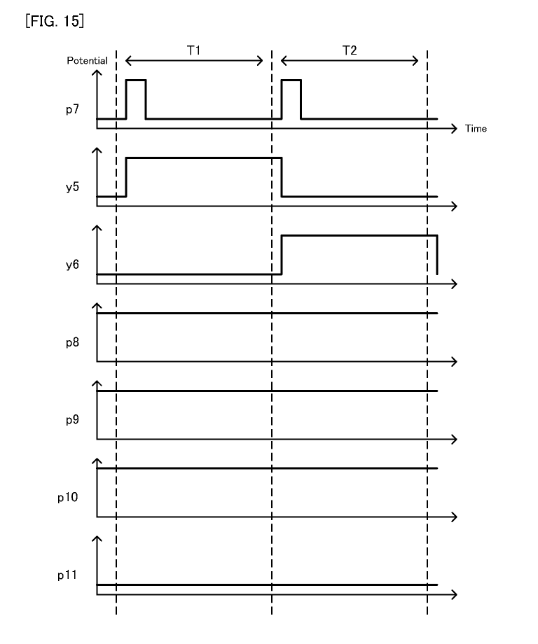

Next, an explanation will be given on the potential signal when the SED in which the electron-emission part 21a (refer to FIG. 11) is formed is driven, with reference to FIG. 15. FIG. 15 is a view showing one example of the potential signal inputted to each terminal and each wire when the SED is driven in the example, to the same effect as FIG. 5.

As shown in FIG. 15, if the SED 21A is driven (in the term T1 in FIG. 15), the potential indicated by the potential signal inputted to the terminal p8 (i.e. the third potential signal) is higher than the potential indicated by the potential signal inputted to the wire y5 (i.e. the fourth potential signal). Incidentally, the potential signal inputted to the terminal p9 is set such that an electric current flows in the emitter region 13e.

Incidentally, the circuit apparatus 3 in the third embodiment may be provided with the HEED instead of the SED 21.

The present invention is not limited to the aforementioned embodiments, but various changes may be made, if desired, without departing from the essence or spirit of the invention which can be read from the claims and the entire specification. A drive method for a circuit apparatus and the circuit apparatus, all of which involve such changes, are also intended to be within the technical scope of the present invention.

1-5. (canceled)

6. A drive method of a circuit apparatus comprising: a cold cathode electron-emission element; a MOS transistor in which one of a source region and a drain region is electrically connected to one electrode of said cold cathode electron-emission element; a first voltage source which is electrically connected to another electrode of said cold cathode electron-emission element; and a second voltage source which is electrically connected to a semiconductor well region in which said MOS transistor is formed, said drive method comprising:
an electron-emission part forming process in which a first potential signal is outputted from said first voltage source and a second potential signal, which is different from the second potential signal, is outputted from said second voltage source so that a forward current flows in a p-n junction between the semiconductor well region and the one region when an electron-emission part is formed in said cold cathode electron-emission element.

7. The drive method of the circuit apparatus according to claim 6, further comprising a driving process in which a third potential signal is outputted from said first voltage source and a fourth potential signal is outputted from said second voltage source so that an electric current flows between the source region and the drain region when said cold cathode electron-emission element in which the electron-emission is formed is driven.

8. The drive method of the circuit apparatus according to claim 6, wherein
said cold cathode electron-emission element is a surface-conduction electron-emitter display, and
said MOS transistor is an N-type MOS transistor.

9. The drive method of the circuit apparatus according to claim 6, wherein
said cold cathode electron-emission element is a high efficiency electron-emission device, and
said MOS transistor is a P-type MOS transistor.

10. A circuit apparatus comprising:
a cold cathode electron-emission element;
a MOS transistor in which one of a source region and a drain region is electrically connected to one electrode of said cold cathode electron-emission element;
a first voltage source which is electrically connected to another electrode of said cold cathode electron-emission element;
a second voltage source which is electrically connected to a semiconductor well region in which said MOS transistor is formed; and
a switching device which is electrically connected to the other of the source region and the drain region,
a first potential signal being outputted from said first voltage source and a second potential signal being outputted from said second voltage source so that a forward current flows in a p-n junction between the semiconductor well region and the one region, at least one portion of said MOS transistor functioning as at least one portion of a diode when an electron-emission part is formed by applying a voltage to said cold cathode electron-emission element.
